(19) United States
(12) Patent Application Publication
(10) Pub. No.: US 2025/0299059 A1
(43) Pub. Date: Sep. 25, 2025

(54) FOUNDATION GENERATIVE ARTIFICIAL INTELLIGENCE (AI) MODEL WITH TRANSFORMER ARCHITECTURE FOR ENVIRONMENTAL, SOCIAL, AND GOVERNANCE (ESG) IMPACT

(71) Applicant: ECORATINGS SOFTWARE SOLUTIONS PRIVATE LIMITED, Noida, Uttar Pradesh (IN)

(72) Inventors: AQEEL AHMED, GHAZIABAD (IN); ADITI BALBIR, NEW DELHI (IN); SHRUTI ANAND, NEW DELHI (IN); AJAY MITTAL, NEW DELHI (IN)

(73) Assignee: ECORATINGS SOFTWARE SOLUTIONS PRIVATE LIMITED, Noida, Uttar Pradesh (IN)

(21) Appl. No.: 19/071,741

(22) Filed: Mar. 5, 2025

Related U.S. Application Data
(60) Provisional application No. 63/567,336, filed on Mar. 19, 2024.

(51) Int. Cl. G06N 3/092; G06F 16/45; G06N 3/045; G06N 3/09

(52) U.S. Cl. CPC G06N 3/092; G06F 16/45; G06N 3/045; G06N 3/09

(57) ABSTRACT

An ESG-specific multimodal AI foundation model is disclosed, featuring a Transformer-based architecture with approximately 30 billion parameters, designed explicitly for environmental, social, and governance (ESG) domain applications. This model uniquely supports extremely long context windows (up to 128,000 tokens), critical for comprehensive ESG analyses of lengthy documents such as sustainability reports and policies. It integrates textual and visual data through gated cross-attention and a Mixture-of-Experts (MoE) architecture, achieving precise multimodal context comprehension. The invention employs Group Relative Policy Optimization (GRPO) reinforcement learning strategy, refining model outputs based on group-relative advantages computed from multiple candidate generations, thus significantly enhancing ESG-specific reasoning and output quality.

### CROSS-REFERENCE TO RELATED APPLICATIONS

The present application claims priority under 35 U.S.C. 119(e) based upon U.S. Provisional Application No. 63/567,336 filed on Mar. 19, 2024, the entire disclosure of which is incorporated herein by reference.

### FIELD OF THE INVENTION

The present invention relates generally to artificial intelligence (AI) foundation models and, more particularly, to an ESG-specific multimodal foundation model and training method designed for environmental, social, and governance (ESG) domain applications.

### BACKGROUND OF THE INVENTION

Background of the Art: Large-scale foundation models (such as large language models and vision-language models) have achieved remarkable success in general-purpose tasks. However, there is an increasing need for AI systems specialized in the ESG domain—encompassing environmental sustainability, social responsibility, and corporate governance issues. ESG analytics often involve processing vast amounts of complex, domain-specific information, including lengthy textual reports, numerical data, and even imagery (for example, satellite images of environmental impact or charts in sustainability reports). Generic AI models not tailored to ESG may lack accuracy, depth of understanding, and nuance when dealing with ESG content. They might misinterpret domain-specific terminology or fail to identify subtle references to ESG criteria, leading to less reliable analyses for critical applications such as compliance auditing, risk assessment, and sustainability planning.

Challenges with Existing Models: Current foundation models face several limitations in addressing ESG tasks. First, typical language models are trained on broad internet text and are not fine-tuned for ESG topics, which cover specialized categories ranging from climate risks to corporate ethics. Without targeted training, these models may produce irrelevant or superficial results in ESG contexts. Second, many existing models have limited context windows (e.g., 2 k to 4 k tokens, with some recent models up to 32 k tokens), insufficient for processing comprehensive ESG reports or policies that can span tens of thousands of words. Important details in lengthy documents may be missed due to context truncation. Third, while some parameter-efficient adaptation techniques (such as adapters or LoRA modules) have been proposed to specialize models to new domains, these often update only a small fraction of model parameters. This can result in incomplete domain adaptation, leaving out subtle internal representations necessary for expert-level ESG reasoning. In high-stakes ESG analysis, partial adaptation might not capture all relevant intricacies of the data, potentially overlooking critical insights.

Need for Multimodal ESG Analysis: ESG evaluations frequently require understanding both text and visual data. For example, environmental assessments might include interpreting satellite imagery of deforestation or pollution, while corporate sustainability reports contain charts or infographics. Social media imagery could provide evidence of labor practices or community impact. Traditional language-only models cannot process visual content, and separate vision models may not integrate textual context. Therefore, a unified multimodal model is needed that can analyze textual and visual information in tandem, preserving context across modalities. Integrating a vision encoder with a language model enables a more holistic analysis of ESG issues—for instance, correlating written descriptions of a site's conditions with actual photographic evidence.

ESG-Specific Classification and Reasoning: ESG subject matter spans a wide range of topics, which are often organized into structured categories (such as environmental, social, and governance factors, each with multiple sub-categories). An ESG-focused model should be able to classify information or generate responses according to these categories, enabling organized insights (e.g., identifying that a piece of text pertains to “Climate Risks and Impact” or “Labor Management”). A robust classification framework with fine-grained ESG categories is needed both to curate the training data and to guide the model's outputs. Moreover, reasoning about ESG topics can involve multi-step logical analysis and compliance with formal criteria or standards (for example, determining if a company's practices meet certain ESG guidelines). Existing AI alignment techniques like Reinforcement Learning from Human Feedback (RLHF) have shown that incorporating human-like evaluation signals can significantly improve the quality and factual accuracy of model outputs. However, standard RLHF typically considers one output at a time. There is an opportunity for an improved reinforcement learning strategy that considers multiple candidate outputs together, using group-based outcomes to better refine the model's behavior. Such a strategy could, for example, reward an answer that not only is correct, but is more comprehensive or better articulated than its peers, thus pushing the model toward higher-quality reasoning.

### SUMMARY OF THE INVENTION

In view of the above challenges, there is a clear need for an ESG-specific AI foundation model that (i) is trained on an extensive, ESG-focused dataset encompassing both text and images, (ii) can handle extremely long documents (on the order of 100 k+ tokens) to capture full context, (iii) employs a comprehensive ESG category classification system throughout training and inference to maintain domain specificity, (iv) undergoes full fine-tuning of its parameters for maximal adaptation to the ESG domain, rather than relying on limited adaptation modules, (v) leverages an advanced reinforcement learning framework to fine-tune the model's outputs for accuracy, coherence, and alignment with ESG values, and (vi) integrates safety controls to mitigate bias or inappropriate content, given the sensitive nature of some ESG topics (e.g., human rights, discrimination, etc.). The present invention addresses these needs by providing a novel ESG-specific multimodal foundation model and associated training and deployment methods.

### BRIEF DESCRIPTION OF THE DRAWINGS

Embodiments will be described, by way of example only, with reference to the accompanying figures wherein:

FIG. 1 is a diagram illustrating the text data ingestion and preprocessing pipeline, including various text sources, extraction modules, filtering mechanisms, and distinct final storage for general and ESG-specific text.

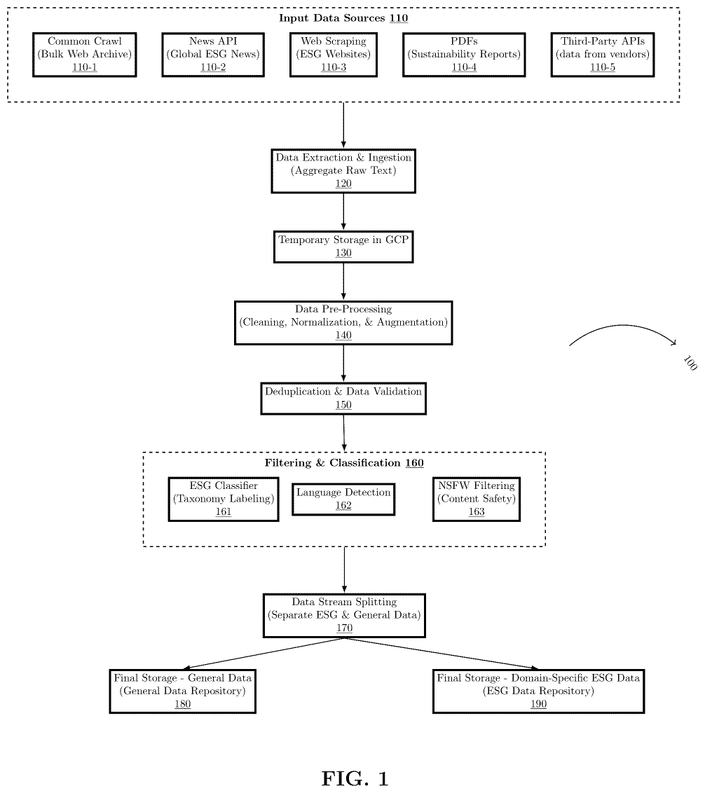

FIG. 2 is a schematic representation of the image data ingestion and preprocessing pipeline, depicting diverse image sources, processing steps such as resizing and normalization, and the division into general and ESG-specific storage.

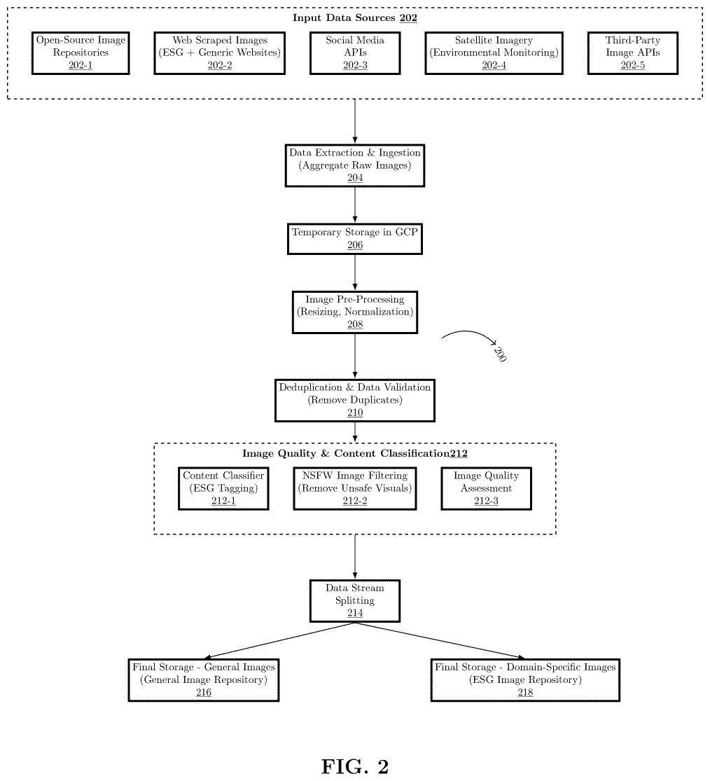

FIG. 3 is a diagram presenting the Environmental taxonomy for ESG classification, outlining a top-level category with subcategories such as waste management, climate risks, and air pollution.

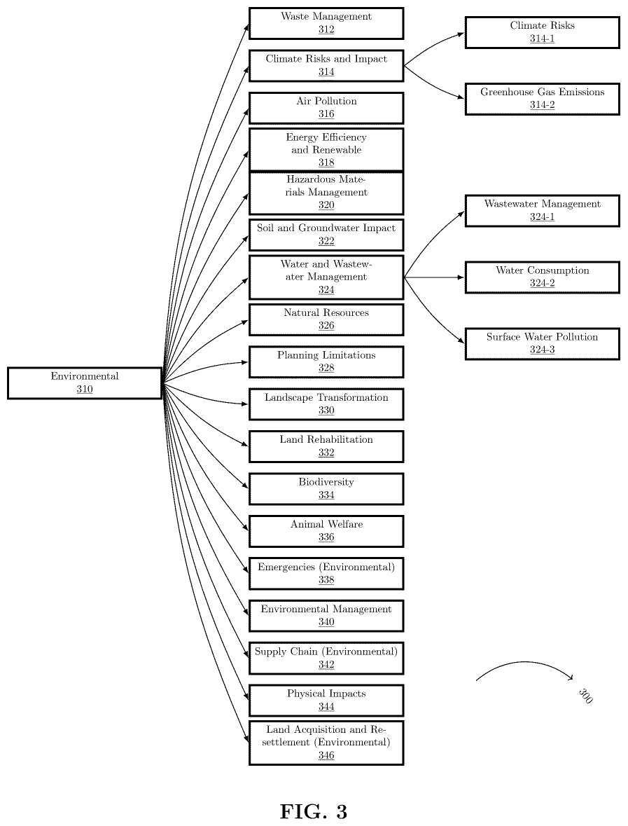

FIG. 4 is a schematic diagram of the Social taxonomy used in ESG classification, highlighting key human-centric topics including community relations, employee safety, and labor management, along with detailed subtopics.

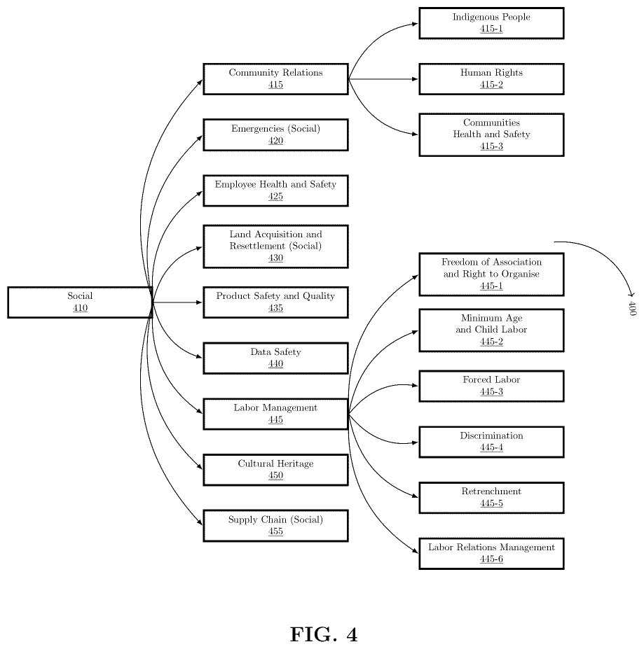

FIG. 5 is a diagram illustrating the Governance taxonomy for ESG content, detailing categories such as economic crime, legal proceedings, corporate governance, and ethical business practices, with further subdivisions.

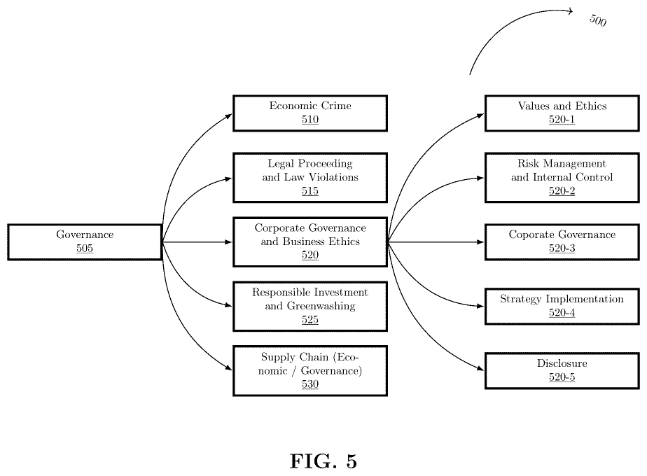

FIG. 6 is a flowchart of the Group Relative Policy Optimization (GRPO) training pipeline, mapping the process from an input query through group sampling, reward evaluation, policy updates, and final model refinement.

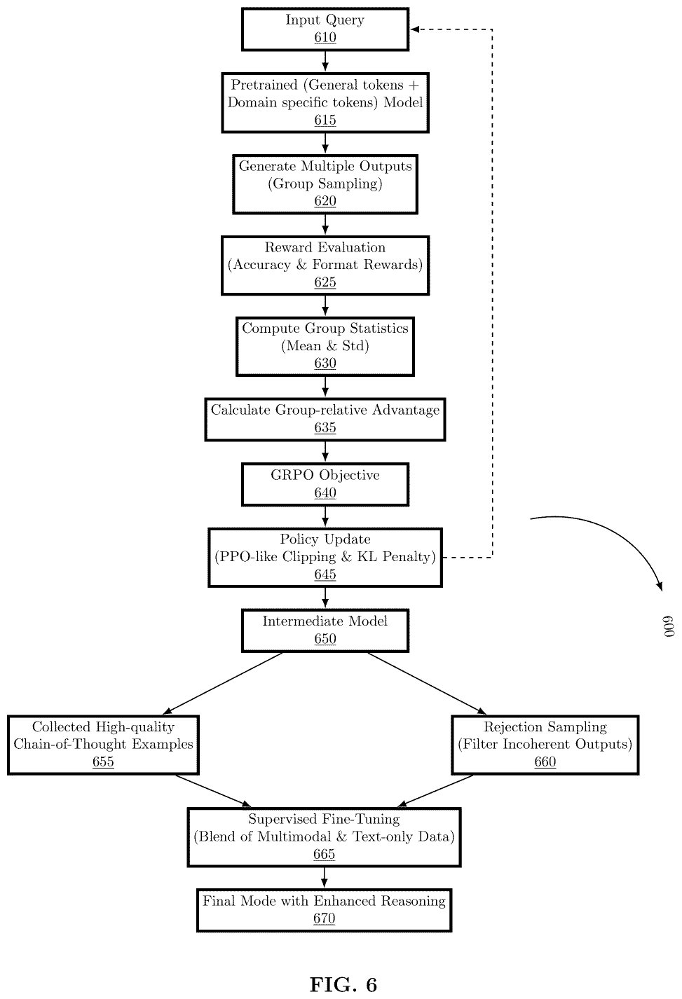

FIG. 7 is a diagram depicting the evaluation frameworks and metrics for model performance, showing various datasets, word- and embedding-based metrics, and technical features such as unified scoring and context chunking.

FIG. 8 is an overview diagram of the training and deployment pipeline for the ESG foundation model, covering data ingestion, categorization, pretraining, architectural enhancements, distributed training, and final deployment.

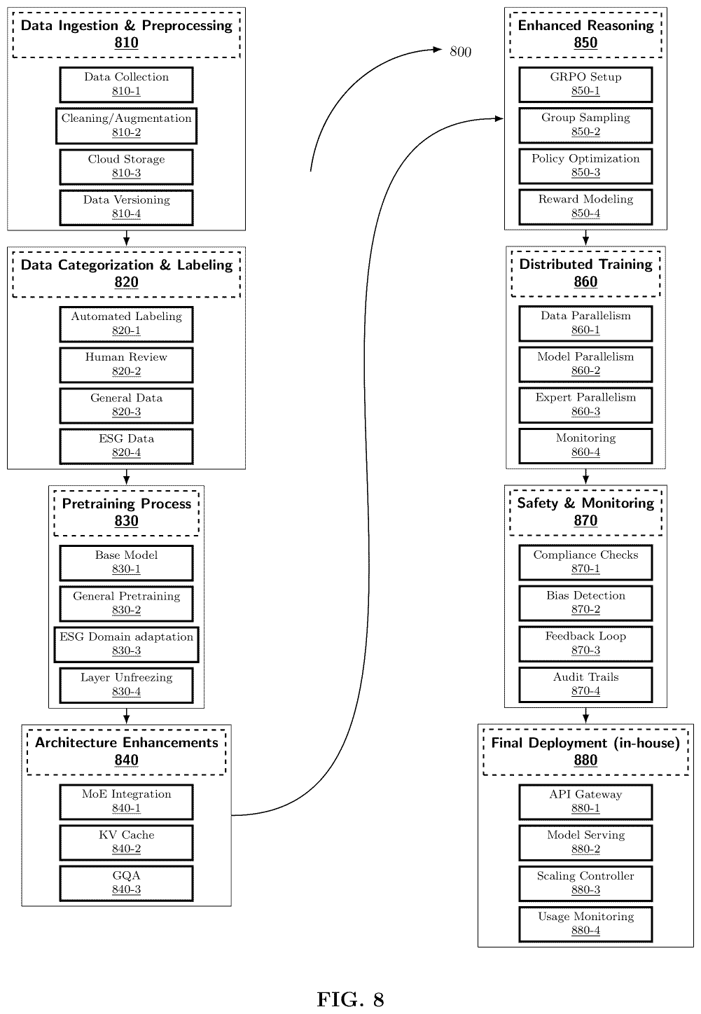

FIG. 9 is a schematic illustration of the multimodal Transformer architecture, showing the integration of text and image inputs via embedding layers, gated cross-attention, and a mixture-of-experts feed-forward network for long-context processing.

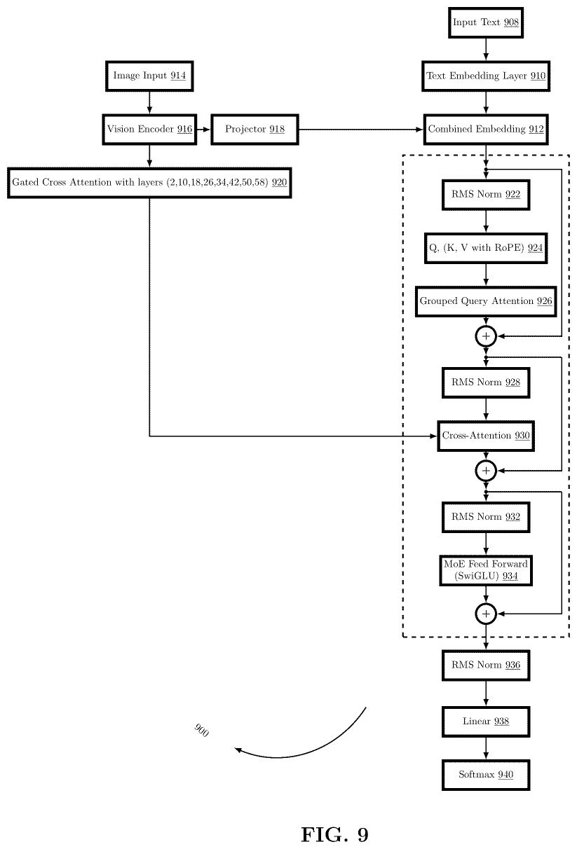

Like reference numerals are used in the drawings to denote like elements and features.

### DETAILED DESCRIPTION OF THE INVENTION

Overview of the ESG Foundation Model: The invention is an AI foundation model tailored for ESG domains, with a 30-billion parameter Transformer-based architecture that accepts both textual and visual inputs. The model is trained on a massive corpus of approximately 20 trillion tokens of data drawn from diverse sources, ensuring broad coverage of general language as well as ESG-specific knowledge. A core aspect of the invention is the integration of a 47-class ESG classification framework used during data preprocessing and training. This framework consists of 46 ESG-related categories plus one non-ESG category, enabling the system to distinguish domain-specific content. By leveraging a specially designed extended-context attention mechanism, the model supports a context window of up to 128,000 tokens, which is critical for ingesting entire ESG reports or multi-chapter documents without truncation. Training is performed via full fine-tuning of all model parameters in multiple phases: an initial pretraining on general and ESG data, followed by an ESG domain adaptation fine-tuning, and a reinforcement learning fine-tuning phase using a Group Relative Policy Optimization (GRPO) approach. The result is a foundation model that can generate analyses, summaries, and answers with expert-level understanding of ESG topics, and that can classify or tag content according to ESG categories when needed.

Data Ingestion and Preprocessing: With reference to 100, the system implements a comprehensive data ingestion pipeline for textual data. Input data sources 110 are used to gather raw text from a variety of channels. In one embodiment, the sources 110 include Common Crawl 110-1 (a large repository of web crawl data), a News API 110-2 for accessing global news articles, web scraping 110-3 routines to collect content from specific websites or forums relevant to ESG, a collection of PDF documents 110-4 (such as annual sustainability reports, regulatory filings, academic papers on ESG), and third-party APIs 110-5 that provide specialized data (for example, databases of ESG ratings, environmental data from government portals, etc.). A data extraction and ingestion module 120 aggregates and streams in data from these sources. As data is collected, it is stored temporarily in a cloud-based storage system indicated at 130 (for example, a Google Cloud Storage bucket or similar cloud data lake environment).

The raw text data then undergoes a data pre-processing stage 140. During this stage, the system performs cleaning operations such as removing HTML tags, boilerplate content, and duplicate entries, normalizing character encoding, and, if needed, applying text augmentation (e.g., paraphrasing or back-translation for data diversity). Following these cleaning operations, the pipeline executes Deduplication & Data Validation 150, which uses hash comparisons or similarity checks to eliminate duplicate or near-duplicate content and verifies that each text segment is within expected length limits, coherent, and well-formed.

With the validated data in place, the process advances to the Filtering & Classification stage 160. Here, Language Detection 162 is applied to each text segment to identify its language, allowing non-English content to be filtered out or routed for translation based on the training strategy. Simultaneously, the ESG Classifier (Taxonomy Labeling) 161 analyzes each text item using a predefined taxonomy of ESG topics (detailed in sections 300, 400, and 500) to assign the appropriate ESG category, while the NSFW Filtering (Content Safety) module 163 screens for disallowed content such as extreme profanity or hate speech.

Once validated, the processed text data is fed into a data stream splitting module 170. This module separates the data into at least two streams: a general data store 180 for non-ESG or general background text, and a domain-specific ESG data store 190 for ESG-related text. Specifically, if the ESG classifier 161 labeled a text as one of the 46 ESG categories, that text is directed into the ESG data repository at 190. If the text was labeled as non-ESG (meaning it does not pertain to the ESG taxonomy), it is placed in the general repository 180. This separation allows the training process to later balance general knowledge learning with targeted ESG learning. For example, general data 180 (which might be a massive corpus of generic text from Wikipedia, books, etc., included via sources like Common Crawl) ensures the model retains broad language understanding, whereas ESG data 190 (a more focused but possibly smaller set of documents specifically about sustainability, social issues, laws, regulations, etc.) ensures expertise in the ESG domain. Both repositories may still be quite large; the ESG-specific corpus can include millions of documents given the breadth of topics (environmental reports, social impact case studies, legal case documents, etc.), contributing significantly to the overall 20 trillion token count used in training.

With reference to 200, a similar pipeline is employed for image data, enabling the multimodal training aspect of the model. Input image sources 202 provide raw images relevant to both general and ESG-specific content. These sources may include open-source image repositories 202-1 (for example, Flickr or Wikimedia Commons images under open licenses that depict environmental scenes, corporate settings, etc.), web scraped images 202-2 from ESG-related websites (such as images in sustainability reports or news articles about environmental and social events), social media APIs 202-3 which can yield images and video frames (for instance, images posted about environmental incidents or community projects), satellite imagery 202-4 (for environmental monitoring, climate impact observation, land use, etc.), and third-party image APIs 202-5 (including possibly paid services that provide collections of relevant images, such as climate data visualizations or industrial operation images). The image ingestion module 204 functions similarly to the text ingestion, retrieving images from these sources and storing them temporarily in cloud storage 206.

Before any images are used in model training, they pass through image pre-processing 208. This step involves operations like resizing (to ensure a uniform input size or aspect ratio suitable for the vision encoder), normalization of pixel values (scaling and mean subtraction as needed for the model), format conversion (e.g., ensuring all images are in RGB), and possibly augmentation (random crops, flips, or color jitter, which can help the model become robust to image variations). The pre-processed images then go into a pipeline akin to the text filter: deduplication and validation 210 removes duplicate images (very common when crawling web data) and drops any corrupted files or images with too low resolution.

The images next undergo image quality & content classification 212. In this stage, several parallel checks are performed. An ESG content classifier 212-1 (which may be an image classification model or a multi-label model) examines each image to determine what it contains and whether it is related to ESG topics. For example, it might recognize images of polar ice caps, factory pollution, solar panels, or workplace environments and tag them with relevant labels (like “Climate Risks”, “Air Pollution”, “Renewable Energy infrastructure”, or “Labor Safety”). This helps in pairing images with the ESG categories similar to how text is labeled. Concurrently, an NSFW image filter 212-2 scans for inappropriate imagery (violent content, adult content, etc.) to exclude such images. Additionally, an image quality assessment 212-3 evaluates technical quality (blurriness, brightness, etc.) and relevance; images that are too distorted or not informative are filtered out. This ensures that only high-quality, pertinent images are kept for training.

After classification and filtering, data stream splitting 214 is performed for images. Just as with text, images determined to be ESG-related (for instance, an image tagged by classifier 212-1 as showing an environmental or social scenario) are separated from general images. Final storage 216 holds the general images, while final storage 218 is designated for domain-specific ESG images. By the end of this ingestion and preprocessing pipeline (100 and 200), the system has constructed two parallel datasets: one large comprehensive set of general data (text+images) and another focused set of ESG-tagged data (text+images). Collectively, these data form the basis of the model's training corpus, which as noted can reach on the order of 20 trillion tokens when counting text sub-word tokens and image tokens (if each image is represented as a sequence of visual tokens or features). The thorough preprocessing with modules 110-218 ensures that the training data is clean, labeled, and suitable for building a reliable model.

ESG Classification Taxonomy: A key part of the invention is the ESG-specific classification framework used throughout data processing and model fine-tuning. 300, 400, and 500 illustrate the hierarchy of ESG categories recognized by the system. In total, there are 46 ESG categories divided among Environmental, Social, and Governance domains (with an additional category for content that does not fall into any of these, i.e., non-ESG).

Focusing first on Environmental categories 310 as shown in 300, the classifier covers topics such as Waste Management 312 (including waste reduction, recycling, disposal practices), Climate Risks and Impact 314, which can be further detailed into subtopics like Climate Risks 314-1 (identifying content discussing climate-related risks) and Greenhouse Gas Emissions 314-2 (specific focus on GHG emission data or policies). The category Air Pollution 316 covers air quality and emission issues. Energy Efficiency and Renewable Energy 318 encompasses content about energy-saving measures and use of renewable sources. Hazardous Materials Management 320 relates to handling and regulation of toxic or hazardous substances. Soil and Groundwater Impact 322 covers contamination and land pollution issues. Water and Wastewater Management 324 deals with water usage, water pollution, and treatment; it has subcategories like Wastewater Management 324-1, Water Consumption 324-2, and Surface Water Pollution 324-3 to differentiate specific water-related topics. Natural Resources 326 covers the use and conservation of natural resources (like minerals, forests). Planning Limitations 328 refer to environmental planning and zoning constraints. Landscape Transformation 330 involves land use changes and their environmental effects. Land Rehabilitation 332 covers restoration of degraded land. Biodiversity 334 pertains to conservation of biological diversity and ecosystems. Animal Welfare 336 covers humane treatment of animals, often in contexts like farming or research. Emergencies (Environmental) 338 includes natural disasters, spills, or accidents impacting the environment. Environmental Management 340 is a broad category for systems and policies managing environmental performance. Supply Chain (Environmental) 342 covers environmental issues in supply chain management (e.g., sourcing raw materials sustainably). Physical Impacts 344 refers to physical environmental changes or damages (like erosion, infrastructure impact by climate). Finally, Land Acquisition and Resettlement (Environmental) 346 touches on environmental aspects of land acquisition projects and the resettlement processes considering ecological impact.

Turning to Social categories 410 in 400, the taxonomy addresses human and social factors. Community Relations 415 is a key category, including how organizations interact with local communities. Subcategories under it include Indigenous People 415-1 (content relating to indigenous rights and impacts), Human Rights 415-2 (broader human rights issues), and Communities Health and Safety 415-3 (public health and safety in communities). Emergencies (Social) 420 covers social aspects of emergency events (e.g., humanitarian response to disasters). Employee Health and Safety 425 deals with workplace safety, occupational health standards, and related regulations. Land Acquisition and Resettlement (Social) 430 covers the social impact of land acquisition (for example, how relocating communities is handled). Product Safety and Quality 435 involves consumer safety issues and quality standards of products (important in ESG when assessing company responsibility). Data Safety 440 addresses data privacy and cybersecurity topics, reflecting social responsibility in handling personal or sensitive data. Labor Management 445 is a broad category for labor practices and rights; it is further detailed by subtopics such as Freedom of Association and Right to Organize 445-1 (unionization rights), Minimum Age and Child Labor 445-2 (preventing child labor, adhering to minimum working age laws), Forced Labor 445-3 (ensuring no forced or bonded labor in operations or supply chain), Discrimination 445-4 (policies and cases regarding non-discrimination in workplaces), Retrenchment 445-5 (how companies handle layoffs or downsizing ethically), and Labor Relations Management 445-6 (overall management of employer-employee relations). Cultural Heritage 450 refers to respecting and preserving cultural heritage in operations (e.g., not disturbing sites of cultural significance). Lastly for social, Supply Chain (Social) 455 covers social issues in the supply chain such as fair labor practices by suppliers, conflict minerals, etc.

For Governance categories 505 shown in 500, the focus is on corporate governance and ethical business practices. Economic Crime 510 covers fraud, corruption, money laundering, or other financial crimes related content. Legal Proceedings and Law Violations 515 includes lawsuits, regulatory violations, and legal compliance issues a company might face (for example, a company being fined for violating environmental laws could fall under both environmental and governance contexts). Corporate Governance and Business Ethics 520 is a broad category covering how a company is run and its ethical standards. Subtopics here include Values and Ethics 520-1 (statements or content about corporate values, ethical principles), Risk Management and Internal Control 520-2 (how the company manages risks and controls processes internally), Corporate Governance (Structures) 520-3 (board composition, shareholder rights, executive compensation—ensuring these structures align with good governance principles), Strategy Implementation 520-4 (the execution of ESG-related strategies or how strategic decisions incorporate ESG considerations), and Disclosure 520-5 (transparency, reporting accuracy, and openness in sharing ESG performance or issues). Another category is Responsible Investment and Greenwashing 525, which covers content about investing in sustainable enterprises, ESG investment funds, and also the negative aspect of greenwashing (where a company may misrepresent its ESG performance). Finally, Supply Chain (Economic/Governance) 530 deals with governance issues in supply chains—for instance, enforcing anti-corruption policies among suppliers or ensuring supply continuity and compliance with laws.

The above taxonomy (310-530 and subcategories) is utilized by the ESG classifier 161 (and image classifier 212-1 for visual data) to tag training data, and it can also be leveraged by the trained model to structure its outputs or analyses. The inclusion of these categories in training allows the model to recognize, for example, that a given paragraph pertains to labor issues 445 or that an image depicts an environmental hazard 338. The 47th category (not explicitly numbered in the figures) is the “Non-ESG” or general category used for anything that doesn't fit into the 46 defined topics. This classification framework ensures that the model's knowledge is well-organized and that fine-tuning can target each ESG aspect. It also means the model can potentially perform classification tasks: given content, it could assign one of the ESG labels or determine it as non-ESG, which is useful for automated ESG content monitoring and retrieval systems.

Model Architecture: The ESG foundation model employs a large-scale Transformer-based architecture adapted for multimodal input and extremely long context, as illustrated in 900. The model comprises a text processing stack and an image processing stack that merge within a unified Transformer. Input text 908 (for example, a sequence of words or tokens from a report or query) is first processed by a text embedding layer 910. This layer converts tokens (which could be words or subword units from a vocabulary) into dense vector embeddings. Positional encoding is integrated at this stage; in this model, Rotary Positional Encodings (RoPE) 924 are applied to the key and value vectors of the attention mechanism. RoPE is chosen for its ability to represent very long sequence positions in a way that is compatible with rotating reference frames, which helps maintain performance even as sequence length grows (important for the 128 k context). The use of RoPE 924 means that the attention mechanism can generalize to long sequences without having to learn absolute position embeddings for every position up to 128 k, which would be infeasible; instead, RoPE imparts a relative positional phase to the attention computation, inherently extending the context window.

The model can also accept an image input 914. When an image is provided (for tasks that require visual context or for multimodal training examples), the image is processed by a dedicated vision encoder 916. In one embodiment, the vision encoder 916 is a convolutional neural network or a Vision Transformer that produces a set of visual feature vectors (for example, patch embeddings if using a Vision Transformer, or feature map vectors if using a CNN). These visual features are then passed through a projector 918, which could be a learned linear transformation or small neural network, to map the image feature vectors into the same dimensional space as the text embeddings. This projection 918 ensures that the model can integrate image information with text information seamlessly. After projection, the image features and text token embeddings are combined-one approach is concatenating the two sequences (treating image features as additional “tokens” in the sequence with their own positional encodings), yielding a combined embedding 912 sequence that contains both modalities. In other embodiments, the combination occurs through cross-attention layers that allow the text and image streams to interact, as described below.

The unified sequence of embeddings (combined embedding 912) is then processed by a stack of Transformer layers. Each Transformer layer in this architecture is enhanced to support multimodal cross-attention and large contexts. At designated layers in the stack, a gated cross-attention mechanism 920 is employed. In the example shown in 900, gated cross-attention is applied at layers 2, 10, 18, 26, 34, 42, 50, and 58 (these specific layer indices are illustrative for a deep model with on the order of 60 layers). The gated cross-attention 920 works as follows: it allows the model to exchange information between modalities (text and image) by performing cross-attention from one modality to the other, but gates it through a learned parameter that can scale the degree of cross-modal interaction. For instance, at a cross-attention layer, the text representation can attend to the image representations, helping the model align textual mentions (like “see figure above showing smoke emissions”) with actual visual data (the image of a factory emitting smoke). The gating means the model can control how much the image influences the text stream (and vice versa), which can stabilize training and let the model fall back to pure text processing if no relevant image information is present. This is especially important in a training regime where many samples might be text-only (no image); the gate can turn down cross-attention in those cases.

Each layer uses RMS normalization 922, 932, 936 at various points. RMSNorm is a normalization technique that normalizes the vector of activations based on its root-mean-square, without introducing learnable bias or scale parameters unless configured to do so. It is similar to LayerNorm but can be more stable or efficient in certain large-scale settings. In the depicted architecture, an RMSNorm 922 is applied prior to the self-attention mechanism. The self-attention uses queries (Q), keys (K), and values (V) with RoPE positional encoding 924 as noted earlier. A distinctive feature here is the use of Grouped Query Attention (GQA) 926. Instead of the standard multi-head attention where each head attends to the entire sequence, GQA 926 partitions the queries (and possibly keys/values) into groups. Within each group, attention is computed locally or with some constraint, effectively reducing the complexity of attention for very long sequences. For example, the 128 k token sequence could be divided into groups where each group of queries only attends to a subset or uses a shared key to query compression. One implementation of GQA could assign multiple query vectors to share the same attention pattern or restrict full attention to within segments, then have limited cross-segment attention, thereby approximating global attention at a lower cost. The result of GQA 926 is that the model can handle extremely long contexts with manageable computational and memory requirements, maintaining performance where standard attention would be prohibitively expensive. GQA thus leverages the idea that not every token needs to attend individually to all 128 k positions; grouping can capture most relevant context interactions.

After the self-attention (with GQA) is performed, the outputs are merged with the input through a residual connection (denoted by “+” in 900). Then another RMS norm 928 is applied in preparation for the cross-attention layer 930 (if it is one of the designated cross-attention layers 920, this cross-attention would allow, e.g., text attending to image or vice versa). The RMS normalization 928, cross-attention mechanism 930, and the corresponding residual (skip) connection are selectively applied only to those specific Transformer layers that incorporate cross-attention 920 between the encoder modalities. Following that, another residual addition and RMS norm 932 occur.

Each Transformer block also includes a Mixture-of-Experts (MoE) feed-forward sublayer 934 with SwiGLU activation. The MoE layer contains multiple parallel feed-forward networks (experts), and a gating network that selects a small number of experts (often 1 or 2) for each input token's output. In the invention, MoE 934 is used to increase the model's capacity to capture diverse patterns in the data (which is especially useful given the wide range of ESG topics) without linearly increasing computation for every token. For example, one expert in the MoE might specialize in legal language (useful for governance topics), while another might specialize in technical environmental science text. During inference or training for a given token, the gating mechanism (which could be a softmax over expert logits conditioned on the token's features) routes that token primarily to the expert most suited to it. The SwiGLU activation (which stands for Swish Gated Linear Unit) is an activation function used inside each expert, known to improve performance in Transformers by gating the transformation (it's an elementwise multiplication of one linear transformation's output with a sigmoid of another linear output, a variation of GLU that uses the Swish function). After the feed-forward computations by the selected experts, their outputs are combined (another residual “+” in 900).

The entire sequence of operations—attention (with cross-attention at certain layers) followed by MoE feed-forward—constitutes one Transformer layer block. This block is repeated N times (denoted by “×N” in 900). In an embodiment, N is set such that the model has on the order of 30 billion parameters. For our case N=60 layers, with hidden size, number of attention heads, and number of experts appropriately chosen, the total parameter count (including embedding matrices, attention projections, feed-forward weights, expert weights, etc.) can reach approximately 30B. The distribution of parameters is influenced by the use of MoE 900 a significant fraction may be in the expert feed-forward networks, which are sparsely activated.

At the final layer of the Transformer stack, an RMSNorm 936 is applied as a last normalization to the Transformer output. Then a linear layer 938 (the output projection) maps the final hidden state of each token to a vector of logits over the vocabulary (for language modeling) or over possible output symbols. This is followed by a softmax 940 to produce a probability distribution over the next-token output. During text generation tasks, the model samples or picks the highest probability token from this softmax to produce the next word. In classification tasks (such as predicting an ESG category for a given input), this output layer can be interpreted differently: for example, a special classification token's output could be fed into a softmax that is interpreted as probabilities of each ESG category vs non-ESG. In one implementation, to enable direct classification, the model could include an extra output head or a prompt-based approach where a question is posed to the model like “Which ESG category does this text belong to?” and the model generates the category name.

Several architectural features come together to enable the 128 k-token context window. The use of RoPE 924 means attention can natively handle long sequences without learning new positional embeddings. The Grouped Query Attention 926 drastically reduces memory usage and computation by structuring the attention calculation for long sequences. Additionally, engineering optimizations such as using a key-value cache (not explicitly shown in 900 but noted as 840-2 in 800 for architecture enhancements) can be employed during inference: after processing a chunk of the sequence, the key and value matrices can be cached so that when new tokens are processed (like streaming input or long text generation), the model doesn't recompute attention for the earlier tokens repeatedly. This allows effectively streaming a long context in smaller segments. Also, chunking with FAISS 724-2 (from 700's technical features) might be used during evaluation to handle long texts by retrieving relevant chunks. The net result is that the model can take as input extremely lengthy documents such as climate research papers, multi-year ESG trend data, or detailed corporate reports without losing context, giving it a significant advantage in tasks requiring deep comprehension over long spans.

Training Pipeline: The training of the model is divided into phases, each addressing different goals, as summarized in 800. The overall process ensures the model learns general language/vision features and then specializes in ESG content, followed by alignment and reasoning enhancement.

The first phase is data preparation, largely covered by the ingestion and preprocessing pipelines described in [019]-[026]. In 800, this is labeled as Data Ingestion & Preprocessing 810. It encompasses data collection 810-1 (gathering raw text and images from sources), cleaning/augmentation 810-2 (where cleaning corresponds to the preprocessing steps we discussed, and augmentation could include things like paraphrasing text, translating text to another language and back, augmenting images with transformations, etc., to increase data variety), cloud storage 810-3 (central storage of the cleaned data, e.g., on distributed file systems or databases), and data versioning 810-4. Data versioning is an important practical aspect: as the data is collected and refined, snapshots are versioned so that experiments are reproducible and one can roll back to earlier data states if needed. This is especially critical in a regulatory context like ESG, where one might need to trace which data was used to train a given model version (for audit purposes).

The next phase is data categorization & labeling 820, which overlaps with the latter part of data preprocessing. In 800, 820 denotes the module where data is labeled and organized. Automated labeling 820-1 refers to the algorithmic assignment of labels using the ESG classifier 161 and image classifier 212-1. The system automatically tags data with ESG categories when confidence is high. Human review 820-2 indicates that some portion of the data labeling is verified or corrected by human experts. This is particularly useful for edge cases where the automated classifier might be uncertain or potentially misclassifying content. For instance, distinguishing whether a particular discussion of “emissions” is about greenhouse gases (Environmental category) or about financial emissions (if any, though unlikely, but say carbon credits accounting which might cross into governance) could require human judgment. Human reviewers ensure the category taxonomy is applied correctly, at least on a sampled subset, which also helps evaluate classifier performance. General data 820-3 and ESG data 820-4 correspond to the results of the splitting: essentially the content labeled as non-ESG goes into general data 820-3, and ESG-tagged content goes into ESG data 820-4. These are the prepared datasets that will be used in model training.

The core model training begins with Pretraining 830. In 800, 830 is the pretraining process that has multiple sub-steps. The base model 830-1 is first initialized. This base model defines the architecture (as detailed in [032]-[040]) and initial parameters. The initial weights were set randomly, and the base model was trained entirely from scratch using sufficient data and computational resources. This approach ensures that the model is fully optimized for the specific ESG and general datasets, without relying on any pre-existing checkpoints.

General pretraining 830-2: In this step, the model is trained on a broad mixture of data, primarily drawn from the general data 820-3 portion of the corpus (which may still include a substantial amount of ESG content that was not explicitly labeled as such, but mostly it's general text and images). The training is conducted in a self-supervised manner: for text, typically using a next-token prediction (language modeling) objective or a masked language modeling objective; for images, possibly a combination of objectives such as image-text contrastive learning (if using approaches like CLIP for aligning text and image embeddings), captioning tasks (predicting text captions from images), and masked image modeling. During this phase, the model learns fundamental language patterns, facts, and some reasoning ability from general data, and fundamental image recognition capabilities. The multimodal aspects (text+image together) are introduced gradually—e.g., some training batches contain only text (to effectively utilize huge text corpora) and some contain paired image-text (to teach vision-language alignment). The context window at this stage might not always be fully utilized at 128 k, but occasional very long documents could be included to ensure the model is exposed to long context handling.

ESG domain adaptation 830-3: After a broad pretraining, the process focuses on the ESG data. In this step, the model is fine-tuned (or further pre-trained) on the ESG-specific dataset 820-4. This involves training on documents and images that are known to be in the ESG categories. The objective functions remain similar (predicting masked tokens, next token, or image-text alignment tasks), but the content is now rich in ESG terms, facts, and relationships. This teaches the model the language and details of ESG topics—for example, it will learn the typical structure of sustainability reports, the meaning of terms like “Scope 3 emissions”, the context of human rights discussions, relevant laws and standards (like ISO 14001 for environmental management, or labor regulations), etc. The model's multi-modal capacity also learns to associate ESG-related images (like an image of a wind farm) with the corresponding textual discussion (renewable energy, climate change mitigation, etc.). Throughout this adaptation, the full parameter set is being fine-tuned. The invention explicitly avoids techniques like freezing most of the model and only training small adapters. Instead, every layer is trainable, but to maintain stability and avoid catastrophic forgetting of the general language abilities, a layer unfreezing schedule 830-4 may be used. For example, initially, only the last few layers are fine-tuned on ESG data while keeping lower layers fixed (so the model doesn't lose basic grammar or knowledge). Then progressively, deeper layers are unfrozen (perhaps in blocks of a few layers at a time) to allow the model to adjust more of its representation to ESG specifics. Eventually, all layers are unfrozen and the model is fully fine-tuned on ESG content. By the end of this phase, the model effectively becomes an ESG expert, while still retaining general language capabilities due to the cautious unfreezing and the mix with some general training.

Notably, unlike parameter-efficient adaptation methods (which might add a small number of extra parameters for new tasks or freeze large parts of the model), this invention leverages full fine-tuning of the base model. The benefit is a more complete internal alignment with ESG features: the model can form new neurons or attention heads specifically to capture ESG-related correlations, which might be impossible if those layers were frozen. The trade-off is the need for more computing resources and careful training to avoid overfitting, but given the size of the ESG dataset (covering many domains and being very large itself), the full fine-tuning yields a robust model.

Architecture enhancements 840: During or after pretraining, certain architectural techniques can be applied or activated to further improve performance, as noted under 840 in 800. The MoE integration 840-1 was already described as part of the architecture; integrating it means possibly during training some layers are converted to MoE layers. MoE training can be tricky (balancing load between experts), but known techniques such as auxiliary loss to encourage usage of experts or limiting the number of tokens per expert (to avoid any single expert taking too much of the load) are employed. The KV cache 840-2 is more relevant to inference (for speeding up deployment), but it is tested and verified during training or validation on long sequences. Ensuring that the model's implementation supports caching keys and values over long contexts is part of the engineering refinement this might not change the model's parameters, but it is a feature of the model's codebase that is validated. The GQA (Grouped Query Attention) 840-3 is a crucial enhancement that is gradually introduced if the initial training starts with standard attention for shorter sequences. As training progresses to longer sequences, the model transitions to using the GQA mechanism to maintain efficiency. This could be done by initially training with a smaller context (like 4 k or 8 k) and then incrementally increasing to 128 k, enabling GQA as needed and verifying that the model continues to train properly (some fine-tuning on long sequences specifically is done to adapt to any differences GQA introduces).

distributed training 860: To manage the extensive computational resources required for training such a large-scale model with approximately 30 billion parameters, the invention employs distributed training 860 methodologies. Data parallelism 860-1 is utilized, wherein the training dataset is divided among multiple GPUs or compute nodes, enabling simultaneous processing of data batches to significantly speed up the overall training time. Complementing this, model parallelism 860-2 distributes segments of the model across multiple devices, efficiently leveraging their combined memory and computational capacity, thus enabling the training of large-scale models that exceed the memory capacity of individual GPUs. Further optimization is achieved through expert parallelism 860-3, specifically within the Mixture-of-Experts (MoE) layers, where individual expert networks are allocated to separate GPUs or compute nodes.

This arrangement allows each expert network to execute in parallel, optimizing resource usage and load balancing during training. Throughout the distributed training process, comprehensive monitoring 860-4 is implemented to continually track resource utilization, model convergence, and system health. This ensures that any computational bottlenecks or issues are swiftly identified and resolved, maintaining high efficiency and stability of the overall training pipeline.

By the end of these steps (810, 820, 830, 840), it proceeds to the enhanced reasoning stage 850. At this stage, the model's reasoning and output coherence are refined further through the Group Relative Policy Optimization (GRPO) method. Specifically, this phase 850 involves setting up the GRPO framework 850-1, performing group sampling 850-2 to generate multiple candidate responses per query, conducting policy optimization 850-3 by updating model parameters based on group-relative advantages, and utilizing advanced reward modeling 850-4 techniques. These combined approaches systematically enhance the model's reasoning capabilities, output accuracy, and alignment with ESG domain expertise and values, culminating in a highly refined final foundation model suited for practical ESG analyses.

Group Relative Policy Optimization (GRPO) Fine-Tuning: The invention employs a reinforcement learning framework called GRPO as part of the fine-tuning pipeline (depicted in 600 and referenced as stage 850 in 800). This can be considered analogous to Reinforcement Learning with Human Feedback (RLHF), but instead of comparing a single model output to a reference or to human preference on a one-by-one basis, GRPO operates on a group of outputs for a given prompt or query.

Referring to 600, the GRPO process begins with an input query 610. This query could be a prompt asking the model to produce a summary, answer a question, or perform some ESG-related task (for example, “List the environmental risks mentioned in this report.”). Initially, the model used here is the one resulting from the supervised pretraining/fine-tuning phase (after 830\840), indicated as the pretrained model 615 (which at this point is already domain-specialized but not yet RL fine-tuned). Rather than generating a single response, the system uses a group sampling 620 approach to produce multiple outputs from the model for the same query. For instance, using different random seeds or slight variations in decoding (like sampling instead of greedy output, or top-k/top-p sampling) to generate, say, N distinct candidate responses. These responses form a group which can be evaluated together.

A reward evaluation module 625 then assesses each of the multiple outputs. The reward signal is designed to capture both accuracy (or relevance) and format quality of the responses. For ESG content, accuracy may involve factual correctness (e.g., did the model correctly identify the risks mentioned in the text?) and completeness (did it miss any important points?). Format rewards might consider clarity, coherence, and whether the response followed any instructions (like providing answers in a certain style or not being too verbose or too brief). In this implementation, a set of expert-defined heuristics—focused solely on formatting and accuracy—is used to evaluate the outputs, eliminating the need for a separately trained reward model.

Once each output in the group has a reward score, the system computes group statistics 630 such as the mean reward and standard deviation of rewards across that set of outputs. These statistics allow the system to determine how each answer fares relative to the others. For instance, if the mean reward is X, an answer that scored significantly above X has outperformed its peers, while one below X underperformed relative to the group.

The next step is to calculate a group-relative advantage 635 for each output. This can be thought of as an analog to the advantage function in reinforcement learning (like in Proximal Policy Optimization (PPO)), but computed with respect to the group's average instead of a value baseline. For example, advantage=reward_of_this_output−average_reward_of_group. An output that is better than average will have a positive advantage, and worse than average yields a negative advantage. The use of group-relative advantage encourages the model to generate outputs that are not just good in absolute terms, but better than most other possible outputs it could have generated, effectively pushing the model to a higher standard of answer quality.

The GRPO objective 640 is then formulated using these advantages. The objective can be a modified policy gradient loss. If we denote the model's policy (its probability distribution over outputs) as π_{θ} and the sampled outputs as actions, GRPO would increase the probability of outputs with positive advantage and decrease the probability of outputs with negative advantage. In practice, this might look similar to the PPO algorithm with an added group perspective. We likely use a loss like: −(Advantage)*log(π_{θ}(output|query)), summed over the group of outputs, and possibly normalized. To ensure stable updates, techniques from PPO are incorporated, such as limiting how much the policy can change at each update (clipping the ratio of new probability to old probability) and adding a KL penalty if the new policy diverges too much from the original model's distribution (to avoid the model drifting away and forgetting its base knowledge or becoming too deterministic).

The policy update 645 thus takes these gradients and adjusts the model parameters θ. This update is applied to yield an intermediate model 650—essentially the original model after one step (or a few epochs) of GRPO fine-tuning. The process from 610 through 645 may be repeated iteratively with many queries (some generated, some from a training set of prompts), gradually improving the model. The GRPO fine-tuning continues until convergence or until a set number of epochs/policy updates have been performed.

During the GRPO process, the system may also collect high-quality chain-of-thought examples 655. “Chain-of-thought” refers to the internal reasoning steps the model might generate (sometimes models are explicitly trained to output their reasoning in a scratchpad before giving a final answer). In some approaches, the model might be prompted to produce a step-by-step explanation along with the answer. High-quality examples of these (where the model's reasoning is sound and leads to a correct answer) can be saved for later use. They could be incorporated into a final supervised fine-tuning dataset to further improve the model's ability to reason or to provide explanations.

The GRPO stage also employs rejection sampling 660 to further refine output quality. After generating multiple outputs, if there are obviously incoherent or irrelevant ones (perhaps determined by a very low reward score or failing some basic checks like content safety), those can be filtered out. The presence of such outlier bad outputs can be detrimental if they are used in the policy update (since they add noise to the gradient). By filtering them out (rejecting them), the policy update can focus on distinguishing between good and great outputs, rather than dealing with trivial bad outputs that the model should anyway learn to avoid. Rejection sampling 660 thus serves as an additional quality gate.

After the reinforcement learning phase, the model is subjected to a final supervised fine-tuning (SFT) 665 as indicated in 600. This stage uses a curated dataset that may include a blend of multimodal training examples and text-only data, possibly with an emphasis on those cases where reasoning or adherence to guidelines is critical. If during GRPO a set of excellent answers (and maybe chain-of-thought traces) were collected 655, those can be included as additional training data in SFT. The supervised objective could be next token prediction on these high-quality responses or a direct regression to producing those outputs given the prompts. Essentially, this step “bakes in” the improvements from GRPO into the model via direct training on the ideal outputs, which can help stabilize the policy (since pure RL can sometimes result in slight instability or mode collapse if not perfectly tuned). The SFT also incorporates some human-verified answers to ESG questions, or edited outputs that correct minor flaws in what the RL produced, thereby fine-tuning the model to a polished state.

At the end of this pipeline, we obtain the final model with enhanced reasoning 670. This final model is the fully-trained ESG-specific foundation model, ready for deployment. It has the benefit of general pretraining, domain-specific knowledge, and alignment via GRPO and SFT to produce responses that are accurate, well-structured, and in line with human expectations for ESG-related queries.

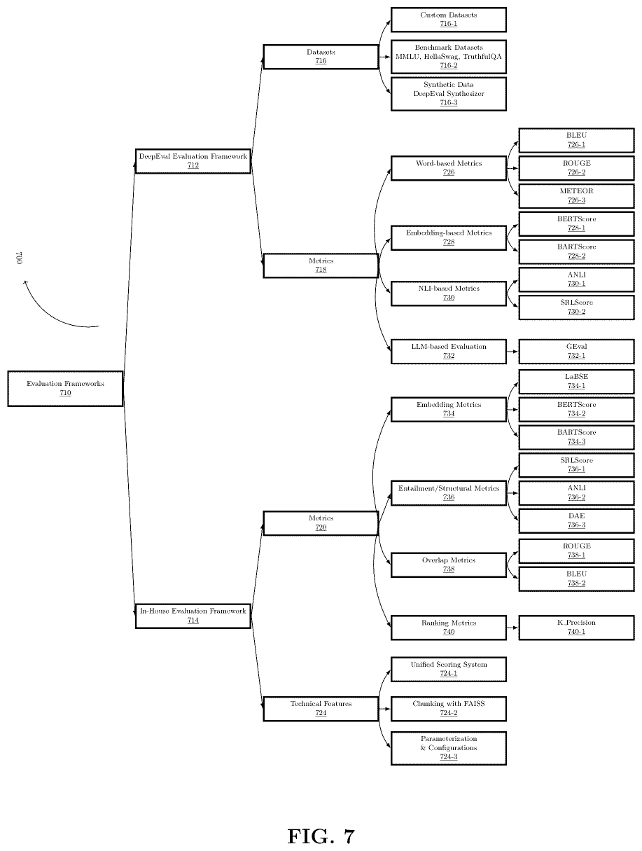

Evaluation Methodologies: Given the high stakes and specialized nature of the ESG model, extensive evaluation is essential to accurately quantify its performance across multiple dimensions. FIG. 7, numeral 700, provides a comprehensive overview of the evaluation frameworks and metrics utilized.

The evaluation system includes a dedicated evaluation platform 710 that orchestrates several evaluation modules. This platform integrates the DeepEval Evaluation Framework 712, a specialized toolkit designed to rigorously test large language models on complex tasks, potentially proprietary or internally developed. Additionally, it incorporates an In-House Evaluation Framework 714 explicitly tailored for ESG scenarios, featuring proprietary datasets reflective of real-world ESG tasks such as summarizing ESG reports or answering compliance-related queries.

A broad set of datasets 716 are employed to thoroughly evaluate the model's capabilities. These include Custom Datasets 716-1, specifically developed for ESG evaluation, encompassing domain-expert-generated Q&A pairs, ESG audit transcripts, and ESG-specific document classification tasks. Benchmark Datasets 716-2 also play a critical role, testing the model's general capabilities beyond the ESG niche. Examples include MMLU for multidisciplinary knowledge assessment, HellaSwag for commonsense reasoning, and TruthfulQA for evaluating truthfulness. Additionally, Synthetic Data 716-3 generated via the DeepEval Synthesizer is used to systematically probe the model's robustness and identify edge cases through automatically generated scenarios and prompts.

Performance metrics 718 are computed to quantify the model's outputs, categorized into distinct groups: Word-based Metrics 726 include BLEU 726-1 for n-gram precision, ROUGE 726-2 for summarization recall, and METEOR 726-3 for synonym and form-sensitive evaluations. These metrics effectively measure textual similarity and summarization accuracy.

Embedding-based Metrics 728 consist of BERTScore 728-1 and BARTScore 728-2, evaluating semantic similarity beyond mere lexical overlap, crucial for assessing meaningful content similarity in varied phrasings.

NLI-based Metrics 730 ensures logical consistency and factual accuracy. ANLI 730-1 tests entailment through adversarial scenarios, while SRLScore 730-2 employs Semantic Role Labeling to verify structural integrity and accuracy of information representation.

LLM-based Evaluation 732 includes GEval 732-1, employing large language models as evaluative referees, providing nuanced judgment on correctness, coherence, and completeness akin to human assessment.

Technical Features 724 enhance the evaluation process comprehensively. The Unified Scoring System 724-1 combines multiple metrics into a consolidated score aligning with human preferences. Chunking with FAISS 724-2 ensures scalable evaluation by segmenting long outputs for precise similarity searches and analysis. Parameterization & Configurations 724-3 facilitate systematic comparisons of various model configurations, supporting targeted ablation studies to confirm individual component contributions.

Embedding Metrics 734, including LaBSE 734-1, BERTScore 734-2, and BARTScore 734-3, measure semantic embedding similarities comprehensively. Entailment/Structural Metrics 736 such as SRLScore 736-1, ANLI 736-2, and DAE 736-3 deeply evaluate factual consistency and logical structure.

Overlap Metrics 738, specifically ROUGE 738-1 and BLEU 738-2, gauge surface-level textual similarity critical in summarization and precise information reproduction tasks. Ranking Metrics 740 such as K Precision 740-1 quantify the ranking accuracy of outputs, especially relevant in retrieval-based ESG tasks.

Evaluation results derived from these metrics guide final model adjustments. For instance, shortcomings identified in TruthfulQA may trigger additional fine-tuning for enhanced truthfulness. Similarly, weaknesses in specific ESG subcategories prompt targeted dataset augmentation. The combination of extensive fine-tuning and GRPO methodology contributes significantly to achieving balanced, robust performance, demonstrated by improvements in metrics such as ROUGE-L, BERTScore, and ANLI accuracy, reflecting the model's practical efficacy in real-world ESG scenarios.

Safety and Bias Mitigation: Throughout the development and deployment of the model, careful attention is given to safety, ethical use, and bias reduction, as illustrated by elements 870 in 800.

During data collection and preprocessing, content filtering components (163 for text, 212-2 for images as described in [020] and [025]) remove overtly unsafe or obscene content. However, bias and safety require more nuanced approaches beyond simply filtering training data. The ESG domain itself includes sensitive topics (e.g., human rights abuses, discrimination issues) that the model must learn to discuss carefully. The model should not perpetuate harmful biases (such as stereotypes in social or governance contexts).

The training process includes compliance checks 870-1 to enforce that the model's outputs stay within acceptable guidelines. One implementation is to have a set of rules or an auxiliary classifier run on the model's outputs (during fine-tuning iterations and in live deployments) to flag content that might be hateful, harassing, sexually explicit, or otherwise against usage policies. If such content is detected during RL or generation, the system can apply penalties to the reward or filter out those outputs (similar to the rejection sampling step, but specifically for safety compliance). Over time, the model learns to avoid generating disallowed content because those attempts do not get reinforced.

Bias detection 870-2 components are integrated to analyze model outputs for signs of bias. For example, after training, the model can be tested with prompts that probe for gender bias, racial bias, etc. (e.g., asking the model to fill in “Men are good at leadership, while women are ______.” and expecting it not to produce a biased completion). Tools like inclusive terminology checks or bias benchmark datasets (like CrowS-Pairs, StereoSet, etc., though not explicitly mentioned in figures) can be part of this detection. If biases are found, further fine-tuning can be done using techniques like contrastive debiasing (showing the model biased vs. unbiased pairs and training it to prefer the unbiased). Additionally, because the model is fully fine-tuned on ESG materials, a lot of which emphasize fairness and equality, the content itself should help mitigate biases (since ESG reports often consciously avoid and even highlight elimination of biases).

The system establishes a continuous improvement feedback loop (870-3). Feedback may originate from user reports (for example, when an end user flags a response as problematic or inaccurate) or from monitoring tools that detect new forms of unwanted output. This feedback is logged and subsequently used either as additional training data or to update the evaluation heuristics in the GRPO process. For example, if the model inadvertently outputs confidential information from its training data—a data leakage issue—this is detected and prompts the addition of a new rule or training example to prevent such behavior. In deployment, this loop enables the model to be incrementally refined through periodic fine-tuning updates as more is learned about its real-world performance.

The platform also maintains audit trails 870-4 for model decisions. Every query the model processes in deployment can be logged along with the model's response and metadata like what version of the model was used, and which safety checks were applied. These logs allow developers or auditors to trace back through the model's outputs, especially important in ESG contexts because one might need to verify why the model gave certain advice or ensure that it wasn't relying on outdated or biased information. The audit trail, combined with internal interpretability efforts (not shown explicitly, but possibly part of technical features or compliance), helps build trust that the model's suggestions in ESG matters can be explained and justified.

Overall, these safety measures (870-1 through 870-4) ensure that the ESG foundation model not only performs well on benchmarks but also adheres to ethical standards and can be responsibly integrated into applications like generating ESG reports, advising on compliance, or informing investment decisions. The cost of an error or biased statement in such domains can be high (e.g., misguiding a company's strategy or offending stakeholders), so the invention emphasizes these controls as first-class features of the system.

Deployment Architecture: After successful training and thorough evaluation, the final model is deployed for use. 800 shows the Final Deployment 880 stage, which can be within an organization's IT infrastructure or offered as a service via an API.

Deployment begins with hosting the model on specialized hardware due to its size (30B parameters and extended context support require significant memory). The system includes an API Gateway 880-1 that provides an interface for external clients (or internal applications) to send requests to the model. This could be a RESTful API or a Python SDK or any suitable interface. The gateway handles authentication, rate limiting, and routing of requests.

The model serving 880-2 is the backend that actually runs the model inference. It likely consists of one or more servers equipped with GPUs or TPUs that have the model loaded into memory. Serving a 30B parameter model with 128 k context involves model parallelism (splitting the model across multiple devices) and efficient batching of requests. The serving stack is optimized for latency—for instance, using the kv-caching so that if a client sends a 128 k-token document and asks a question, the system can cache the encoding of that document so follow-up questions on the same document don't require reprocessing the entire context from scratch.

A scaling controller 880-3 monitors the load on the system. If there are many incoming requests, it can spin up additional instances of the model (horizontally scaling by launching more GPU workers, for example) to handle the traffic. It can also allocate more resources if one request is particularly heavy (for example, maybe some requests ask the model to process a maximum 128 k context plus generate a long report, which is computationally intensive). The scaling controller ensures high availability and consistent performance under varying loads.

Usage monitoring 880-4 is also in place in deployment. This overlaps with audit trails but is more about real-time analytics and ensuring the system is used correctly. It logs statistics like number of requests, types of queries being asked (to detect if someone might be trying to get the model to output disallowed content, for example), latency per request, and system performance metrics. If any usage goes outside expected norms (like a user asking an extremely large number of questions rapidly, indicating possible misuse or a need to upsell more capacity), alerts can be raised. Monitoring also helps in continuing to evaluate the model post-deployment: by sampling random anonymized queries and the model's answers, the developers can see if new types of errors are appearing, feeding into the feedback loop for future improvements.

The deployed system effectively becomes a powerful tool for ESG analysis. In practical use, a company might use it to automatically analyze their ESG performance reports and get a summary of key risks and opportunities. Investors might query the model about a company's social responsibility issues to inform their decisions. Regulators could use it to scan through company disclosures quickly. Because of the extensive training and the integrated classification framework, the model can output not just generic answers but structured insights—for example, it could answer: “This document primarily pertains to categories 314 (Climate Risks and Impact) and 520 (Corporate Governance and Business Ethics), highlighting issues in 314-2 (Greenhouse Gas Emissions) and 520-5 (Disclosure).” That demonstrates an understanding aligned with the ESG taxonomy. Additionally, thanks to the reinforcement learning fine-tuning, the model is likely to provide its answers with clear reasoning, perhaps even offering to explain its chain of thought if asked (since chain-of-thought data was used in fine-tuning, the model could be prompted to share its reasoning process on complex questions).

It should be noted that while the above description details one embodiment of the invention, variations are possible. For example, the model size (30B) and data size (20 T tokens) can be adjusted depending on available resources—the architecture could scale up further or be pruned down for smaller deployments. The context window of 128 k could be traded off for smaller if needed, but the described GQA method would allow even larger if desired. The ESG taxonomy could be expanded or refined (some implementations might use a different breakdown, or add industry-specific subcategories). The GRPO algorithm might be applied with different numbers of samples or combined with human feedback at times (hybrid human+group feedback). Such variations, enhancements, or reductions are considered within the scope of this invention as defined by the claims, as long as they employ the key features: multimodal ESG-focused training with an extended context window, full model fine-tuning, and group-based RL optimization for improved performance.

### INDUSTRIAL APPLICABILITY

The ESG-specific multimodal foundation model described herein delivers significant benefits to organizations, public-sector bodies, and broader stakeholder communities, where automated and accurate ESG analysis is of paramount importance. Below are illustrative domains and use cases.

Compliance and Reporting Organizations that must adhere to evolving regulatory frameworks—such as GRI, SASB, or local emission mandates—can deploy the model to parse, classify, and summarize voluminous ESG-related documents. By supporting extremely long context windows, the system ensures that entire sustainability reports or detailed governance policies are processed with minimal truncation.

Corporate Sustainability Analysis: Enterprises, including those in manufacturing, energy, or finance, can leverage the model to monitor and assess their ESG performance. The multimodal architecture—capable of integrating satellite images, operational data, and textual disclosures—enables a comprehensive approach to identifying climate risks, labor practices, and corporate governance gaps.

Supply Chain Audits: Given the model's ability to handle diverse text and visual data, global supply chain audits become more efficient and systematic. Companies can rapidly scan supplier reports, inspection photos, and social media evidence to detect potential ethical or environmental violations, ensuring compliance with anti-corruption and fair labor standards.

Financial Services and ESG Investing: Financial institutions requiring real-time ESG insights on potential investments can utilize the model's classification and summarization capabilities to review corporate sustainability disclosures, governance structures, or emerging controversies. This integrated perspective can inform investment decisions, risk assessments, and portfolio strategies aligned with responsible investing objectives.

Regulatory Oversight and Policy Development: Government agencies and policy-makers can apply the invention to analyze a large corpora of stakeholder inputs, legal filings, and environmental impact statements. The extended context window accommodates lengthy legislative documents, while the domain-specific training ensures accurate classification of environmental, social, and governance factors.

Automated Governance & Ethics Checks Legal teams and auditors benefit from a system capable of pinpointing irregularities in governance disclosures—e.g., identifying gaps in board composition, suspected corruption, or misalignment with stated corporate values. The integrated approach fosters transparent reporting and reduces the likelihood of undiscovered malpractice.

Global and Multilingual Deployments: Though the present description focuses on English ESG data, the underlying architecture supports multilingual adaptation, enabling international organizations to evaluate sustainability reports in diverse languages. The large context window and the model's fine-grained taxonomy facilitate uniform ESG standards cross-culturally.

By enabling these and other applications, the invention aligns with industrial requirements to handle complex, multimodal ESG data at scale. Its advanced reinforcement learning fine-tuning ensures that outputs are not only coherent and complete but also hold up to high-stakes use cases—such as regulatory disclosures, stakeholder communications, and strategic decision-making. Consequently, the invention stands to promote more efficient compliance, transparent governance, and responsible resource management across various industrial and commercial environments.

1. A computer-implemented method for training an ESG-specific multimodal AI foundation model, the method comprising:
(a) Ingesting and preprocessing training data from a plurality of data sources, including textual documents and images, wherein the training data is filtered to remove unsafe content and is labeled using an ESG classification framework distinguishing 46 ESG categories and a non-ESG category;
(b) Providing a multimodal Transformer model having a text encoder and a vision encoder, the model comprising at least 30 billion parameters and configured with a context window of at least 128,000 tokens through a grouped query attention mechanism;
(c) Pretraining the model on a corpus of approximately 20 trillion tokens of combined general-domain and ESG-specific data, including feeding text through a text embedding layer and images through an image encoder and projector, and updating model parameters on a language modeling objective to learn initial representations;
(d) Fine-tuning the model on ESG-specific data by training on content labeled with ESG categories, wherein substantially all model parameters are updated (without employing parameter-efficient adapter modules), further comprising gradually unfreezing layers of the model during fine-tuning to allow full-model adaptation to ESG domain features;
(e) Applying a group Relative policy optimization (GRPO) reinforcement learning procedure to the fine-tuned model, the GRPO procedure including:
(i) generating a plurality of candidate outputs from the model for each input prompt;
(ii) Evaluating each candidate output using a set of expert-defined heuristics that assign a reward score based on factual accuracy and adherence to formatting guidelines;
(iii) computing a group-relative advantage for each candidate output by comparing its reward to a reward statistic of the group; and
(iv) updating the model's parameters using a policy gradient that increases the likelihood of outputs with positive group-relative advantage and decreases the likelihood of outputs with negative group-relative advantage, with a constraint on policy change to stabilize training;
(f) Performing a supervised fine-tuning on the model after the reinforcement learning, using a training set of high-quality responses (including multimodal examples and chain-of-thought explanations) to further adjust the model's outputs toward correctness and clarity; and
(g) Evaluating the trained model using one or more evaluation frameworks by testing the model on ESG-related tasks and general benchmarks, and computing a plurality of metrics including BLEU, ROUGE, METEOR, BERTScore, BARTScore, and factual consistency scores, thereby verifying that the model can accurately classify and generate ESG-specific content.

2. The method of claim 1, wherein ingesting and preprocessing training data (step (a)) comprises using an ESG classifier to tag textual content with specific ESG sub-categories and a parallel content filtering module to exclude not-safe-for-work (NSFW) or irrelevant data, resulting in a curated ESG training dataset and a separate general dataset for balanced training.

3. The method of claim 1, wherein the grouped query attention mechanism in the Transformer model (step (b)) partitions or compresses attention computation for extended context lengths, and wherein rotary positional embeddings (RoPE) are applied to attention keys and values to enable the model to learn positional information over sequences of up to 128 k tokens.

4. The method of claim 1, wherein fine-tuning the model on ESG-specific data (step (d)) involves full-model fine-tuning of all Transformer layers without freezing, and further wherein a layer unfreezing schedule is utilized such that lower layers of the model are incrementally unfrozen during training to integrate ESG knowledge while preserving stability of previously learned general language capabilities.

5. The method of claim 1, wherein the GRPO reinforcement learning procedure (step (e)) employs expert-defined heuristics to assign a reward based on answer quality, and wherein the policy update employs Proximal Policy Optimization (PPO) techniques including clipping the policy update and adding a Kullback-Leibler divergence penalty to ensure the updated model remains close to the pre-trained policy distribution.

6. The method of claim 1, wherein step (e)(i) of generating multiple candidate outputs uses stochastic decoding strategies with different seeds or sampling parameters to produce diverse responses, and wherein step (e)(iii) includes computing the mean reward of the group as said reward statistic, such that the group-relative advantage for each output is its reward minus the mean reward.

7. The method of claim 1, further comprising, during the GRPO procedure, a rejection sampling step in which any candidate outputs that fail predefined coherence or safety checks are discarded prior to computing the group reward statistics, thereby preventing incoherent or policy-violating outputs from influencing the policy update.

8. The method of claim 1, wherein performing supervised fine-tuning (step (f)) includes incorporating a set of chain-of-thought examples where the model's intermediate reasoning steps are annotated, thereby teaching the model to generate transparent reasoning or explanations for complex ESG questions as part of its response.

9. The method of claim 1, wherein evaluating the trained model (step (g)) comprises testing the model on at least one ESG-specific evaluation dataset and standard benchmarks including Massive Multitask Language Understanding (MMLU), HellaSwag, and TruthfulQA, and wherein evaluation further includes computing embedding-based metrics and entailment-based metrics to assess semantic similarity and logical consistency of the model's outputs relative to references.

10. The method of claim 1, further comprising implementing safety and bias mitigation measures during training and inference, including automatic compliance checks on model outputs to flag or penalize toxic or biased content, and a feedback loop that logs outputs and user feedback for continuous refinement of the model's responses.

11. A computing system for deploying and utilizing an ESG-specific multimodal AI foundation model, the system comprising:
(a) One or more processors and memory storing a trained AI foundation model having a Transformer-based architecture with approximately 30 billion parameters, the model including a text processing module and a vision processing module integrated to handle multimodal input;
(b) a data storage subsystem storing ESG-related data and a taxonomy of ESG categories utilized by the model for content classification;
(c) an inference engine configured to receive an input that includes up to 128,000 tokens of text and optionally one or more images, and to process the input using the trained model to generate a response, wherein the model's architecture comprises:
(i) a text embedding layer for encoding input text tokens, and a vision encoder and projector for encoding and projecting image data into a text-comparable embedding space;
(ii) a plurality of Transformer layers with self-attention mechanisms employing grouped query attention and rotary positional embeddings to support extended context lengths;
(iii) gated cross-attention sub-layers (at a set of designated layers) that fuse information between textual and visual representations; and
(iv) Mixture-of-Experts feed-forward sub-layers within the Transformer layers to increase model capacity, each MoE layer having multiple expert networks with a gating mechanism to route token representations to one or more selected experts;
(d) A deployment interface comprising an API gateway through which external applications can query the model and receive results, and a scaling controller that dynamically allocates computational resources based on system load; and
(e) a monitoring and safety module that tracks the system's usage and output, including components for bias detection, compliance checking of outputs against predetermined safety rules, and audit logging of interactions for review, wherein the computing system is configured to utilize the trained model to classify input content into ESG categories and to generate analytical or conversational responses about ESG topics, with improved long-text reasoning and multimodal understanding enabled by the model's architecture and training.

12. The system of claim 11, wherein the text processing module and vision processing module of the model operate jointly such that the model can accept multi-modal inputs (an input text document alongside an image) and produce a unified response, and wherein gated cross-attention 920 layers allow the text representation to attend to image-derived embeddings (and/or vice versa) in the Transformer, the gating providing controllable influence of visual context on the textual output.

13. The system of claim 11, wherein the model's self-attention uses a grouped query attention mechanism to partition attention for long sequences, and wherein rotary positional encoding is applied in computing attention scores, thereby enabling the model to maintain context over extremely long inputs on the order of 10⁵ tokens without significant loss of coherence.

14. The system of claim 11, further comprising the API gateway and scaling controller, wherein the API gateway handles incoming requests by batching and routing them to the inference engine, and the scaling controller monitors throughput and spawns additional inference processes or loads-balances across server instances to handle high volumes of queries to the 30B-parameter model with low latency.

15. The system of claim 11, wherein each Transformer layer of the model includes a Mixture-of-Experts layer with a plurality of expert feed-forward networks, and wherein an expert parallelism scheme is implemented on the system's hardware such that different subsets of experts are hosted on different processors or devices, allowing the system to utilize parallel computation for the experts selected by the gating mechanism without memory overload.

16. The system of claim 11, further comprising a training module or environment that remains operable after deployment to perform periodic fine-tuning updates, wherein the monitoring and safety module provides feedback from logged queries to the training module to refine the model's performance or address any newly discovered biases or errors in the model's responses.

17. The system of claim 11, wherein the monitoring and safety module includes a compliance check component that uses predefined rules and machine learning classifiers to intercept any model output that contains disallowed content or policy violations, and an associated remediation mechanism to either redact such content or replace the response with a warning, thereby ensuring the system's outputs remain in compliance with ESG communication standards and general AI safety guidelines.

18. A non-transitory computer-readable medium storing instructions that, when executed by one or more processors, cause the processors to perform a method for training and utilizing an ESG-specific AI model, the method comprising the steps of:
(i) Preprocessing a large-scale multimodal dataset by collecting text and image data from multiple sources, filtering out unsafe content, and labeling the data with ESG category labels using an automated classifier;
(ii) Training a 30-billion-parameter multimodal Transformer model on said dataset, including encoding text with a text embedding layer, encoding images with a vision encoder, and integrating the modalities in a Transformer with grouped query attention and gated cross-attention, the training involving a general pretraining phase followed by full-parameter fine-tuning on ESG-labeled data;
(iii) Fine-tuning the model using a group relative policy optimization (GRPO) algorithm, wherein multiple output candidates are generated for training prompts and evaluated as a group to determine a policy gradient update that improves the model's responses relative to its own alternatives;
(iv) Evaluating the model's performance on a set of ESG-specific tasks and general language understanding benchmarks using an evaluation framework that computes overlap-based metrics, embedding-based metrics, and logical consistency metrics to verify model quality; and
(v) Deploying the trained model via an API such that the model can receive input queries up to a 128 k-token length and produce ESG-aware outputs, while monitoring usage and filtering outputs for safety, wherein the instructions include code for adjusting all model parameters during fine-tuning (eschewing adapter-based training) and code for implementing the GRPO reinforcement learning procedure to enhance the model's reasoning and alignment with ESG criteria.

19. The non-transitory computer-readable medium of claim 18, wherein the instructions for training the Transformer model include instructions to implement a rotary positional embedding scheme to enable extended sequence lengths and instructions to incorporate mixture-of-experts layers in the Transformer, each expert being conditionally activated, thereby allowing the model to learn specialized transformations for different ESG topics within the single unified model.

20. The non-transitory computer-readable medium of claim 18, wherein the instructions for deploying the trained model include instructions to utilize a feedback loop mechanism that takes user feedback or flagged output instances and enters them into a further training or adjustment routine, such that the ESG-specific model continually improves and remains up-to-date with respect to correctness, bias mitigation, and adherence to content guidelines over time.
